(19) United States
(12) Patent Application Publication
(10) Pub. No.: US 2002/0117441 A1
(43) Pub. Date: Aug. 29, 2002

(54) Fuel processing and filtering apparatus

(76) Inventors: Paul B. Smith, Ann Arbor, MI (US); Kevin J. Rucinski, Saline, MI (US)

Correspondence Address: Todd L. Moore, Suite 624, 3001 West Big Beaver Road, Troy, MI, 48084, US

(21) Appl. No.: 09/778,552

(22) Filed: Feb. 7, 2001

(51) Int. Cl. B01D 27/00

(52) U.S. Cl. 210/440

(57) ABSTRACT

An improved fuel processing and filtering apparatus for separating water and impurities from fuel. The present invention provides a housing having an upper portion for filtering fuel and a lower portion for collecting water and contaminants. A filter media housed 5 within the upper portion of the housing filters fuel by allowing fuel to flow from an unfiltered side of the filter media toward a filtered side of the filter media. A fuel inlet directs fuel to the unfiltered side of the filter media, and a fuel outlet communicates and directs fuel from the filtered side of the filter media to the outside of the lower portion of the housing. A flow director connected to the filter media and extending along the unfiltered side of the filter media directs fuel from the fuel inlet along an outer surface of the flow director to settle out water and contaminants from the fuel. A plate separating the upper portion and the lower portion of the housing directs fuel toward the unfiltered side of the filter media and has at least one narrow opening extending therethrough for allowing water and impurities to pass through the opening to the lower portion of the housing.

### FIELD OF THE INVENTION

The present invention relates to an improved fuel processor, and particularly, a fuel processing and filtering apparatus having a plate with a plurality of slots extending therethrough for directing water and contaminants to a lower portion of the fuel processor while directing the separated fuel to a filter media in an upper portion of the fuel processor.

### BACKGROUND OF THE INVENTION

In the past, diesel fuels and other hydrocarbon fuels were plentiful and relatively inexpensive, and few problems existed regarding the quality of fuel. Refineries, distributors, and retailers were careful to keep water out of fuel and not to pump out heavy settlings from the bottom of storage tanks. However, in more recent times, government regulations, fuel stock availability, and fuel refinery capacity have led fuel suppliers to provide fuel with increased quantities of water and other contaminants. This has resulted in lower quality fuel oils that contain substantially more impurities such as water, waxes, paraffins, heavy compounds, and particulates which can be very disruptive to the proper operation of fuel oil consuming devices, such as diesel engines. Such impurities may cause fuel line blockages, and when exposed to cold weather conditions, may cause fuel lines to freeze.

In order to overcome the above mentioned fuel quality problems, operators of diesel engine powered equipment have developed a variety of fuel processing devices which may serve as water separators, impurity filters, and fuel heaters. Such devices include those which are essentially stand-alone units and are mounted remotely from the engine thereby requiring dedicated mounting provisions, mounting hardware, and fuel conduit connection devices. Due to the expense and time needed to install these devices, many operators of diesel engine powered equipment avoid installing such devices and consequently experience problems related to fuel contamination and/or fuel flow stoppage.

Most motor vehicle diesel engines have a filter mounting block which accommodates a particulate filter. The particulate filter may be a spin-on filter which employs an integral filter element inside a throw-away canister wherein the spin-on filter is threaded onto a boss on the filter mounting block. Alternatively, the filter may be a cartridge type which employs an outer canister having an internal replaceable filter element. These fuel processors, by virtue of being designed to mount to existing filter mounting blocks, may have fuel inlet and outlet ports within the upper portion of the canister housing. Without taking steps to control the type of flow within these types of fuel processors, filter contamination and poor thermal efficiency can result when the incoming fuel is permitted to directly contact the surface of the filter element before the fuel is heated and water and other impurities are removed.

Other known fuel processor designs utilize an upright, enclosed housing having a lower collection chamber for housing fuel and contaminants and an upper chamber for filtering fuel. The lower collection chamber allows water and contaminants to settle out from the fuel while the lighter weight fuel rises to the upper portion of the housing to be filtered. Although these designs have merit, they typically have fuel inlets that communicate with the lower portion of the housing. The turbulent flow of fuel into the lower portion of the housing may cause the fuel to mix with the water and contaminants in the lower portion of the housing, thus causing the filter media to filter much of the water and contaminants from the fuel. The more water and contaminants in the fuel, the faster the filter media becomes clogged, thereby reducing the life of the filter media.

It would be desirable to provide a fuel processing and filtering apparatus that separated water and impurities from the fuel prior to filtering the fuel in an efficient and inexpensive manner.

### SUMMARY OF THE INVENTION

The present invention provides a fuel processing and filtering apparatus that separates water and impurities from the fuel prior to the fuel being filtered. The apparatus provides a housing having an upper portion for filtering fuel and a lower portion defining a collection chamber. A filter media is housed within the upper portion of the housing for filtering fuel wherein fuel flows from an unfiltered side toward a filtered side of the filter media. A fuel inlet directs fuel to the unfiltered side of the filter media, and a fuel outlet communicates with the filtered side of the filter media to direct filtered fuel out of the housing. A flow director is connected to the filter media and extends along the unfiltered side of the filter media. Fuel flows from the fuel inlet along an outer surface of the flow director to settle out water and contaminants from the fuel. A plate separating the upper portion and the lower portion of the housing directs fuel toward the unfiltered side of the filter media while at least one narrow opening extending through the plate allows water and impurities to pass through the opening to the lower portion of the housing.

### BRIEF DESCRIPTION OF THE DRAWINGS

The description herein makes reference to the accompanying drawings wherein like reference numerals refer to like parts throughout several views and wherein:

FIG. 1 is a cross-sectional perspective drawing of the fuel processing and filtering apparatus of the present invention.

FIG. 2 is a perspective drawing showing the top portion of the base plate of the present invention.

FIG. 3 is a perspective drawing showing the bottom portion of the base plate of the present invention.

FIG. 4 is a bottom view of the base plate of the present invention.

FIG. 5 is a cross-sectional view in the direction of arrows 5-5 in FIG. 4.

### DESCRIPTION OF THE PREFERRED EMBODIMENT

Referring to the drawings, the present invention will now be described in detail with reference to the preferred embodiment.

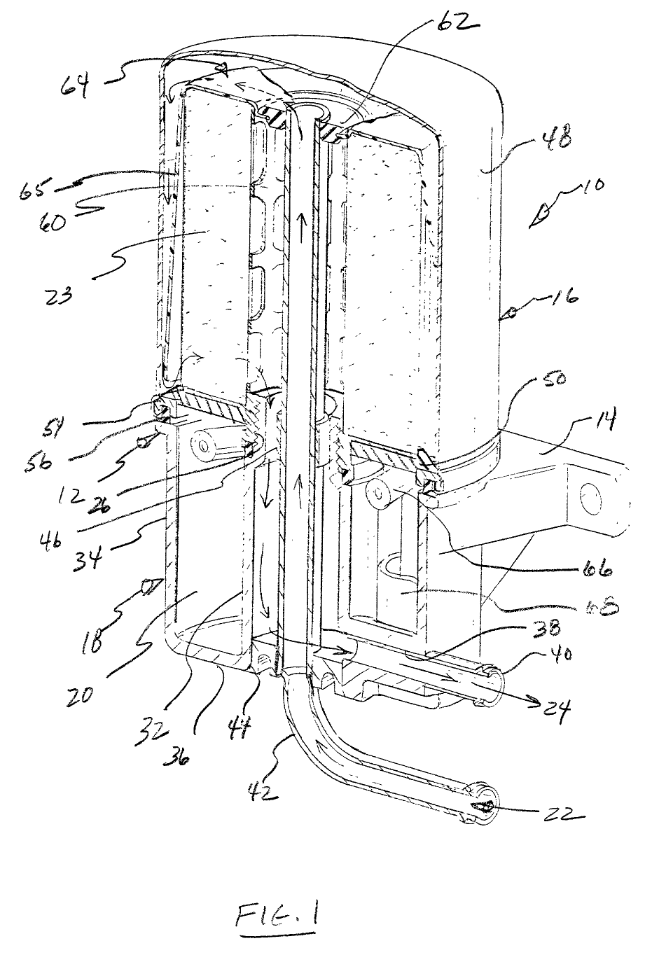

FIG. 1 shows a fuel processing and filtering apparatus 10 of the present invention. The apparatus 10 provides an enclosed housing 12 mounted vertically upright by a bracket 14. The housing 12 has an upper portion 16 for filtering fuel and a lower portion 18 for defining a collection chamber 20. A fuel inlet 22 communicates and directs fuel (not shown) through the bottom of the lower portion 18 of the housing 12 to the top of the upper portion 16 of the housing 12. A filter media 23 is disposed within the upper portion 16 of the housing 12 for filtering fuel. Filtered fuel is communicated and directed through a fuel outlet 24 from the upper portion 16 of the housing 12 through the lower portion 18 of the housing 12.

The fuel inlet 22, fuel outlet 24, and collection chamber 20 are formed in the lower portion 18 of the housing 12 by two concentric tubular cylinders 32, 34 which are closed at one of their ends by a bottom 36. The space created between the concentric cylinders 32, 34 and the bottom 36 defines the collection chamber 20. The fuel inlet 22 provides a metallic fuel inlet tube 42 leading into the lower portion 18 of the housing 12 from a fuel source (not shown) and extending upward through the inner cylinder 34 of the lower portion 18 and into the upper portion 16 of the housing 12. The fuel inlet tube 42 is sealed and secured at the bottom of the inner cylinder 34 by a shaped plug 44. The fuel inlet tube 42 is further supported inside the inner cylinder 34 by a small tubular shaped cylinder 46 that is supported by several ribs extending radially inward from and integrally to the inner diameter of the inner cylinder 34. The fuel inlet tube 42 is received by and extends through the rib supported cylinder 46. The fuel outlet 24 is defined by the spacing created between the inner cylinder 34 and the fuel inlet tube 42. A bore 38 is formed in the bottom 36 of the lower portion 18 of the housing 12 and extends from the spacing between the inner cylinder 34 and the fuel inlet tube 42 to the outside of the lower portion 18 of the housing 12. A fuel outlet tube 40 is disposed within the bore 38 and extends outwardly from the housing 12 to communicate with a fuel consuming apparatus, such as a diesel engine (not shown).

To provide for the quick and simple changing of the filter media 23, the upper portion 16 of the housing 12 is preferably threaded on to the lower portion 18 of the housing 12 as a spin-on filter. The upper portion 16 of the housing 12 has an inverted cup-shaped outer casing 48 with a base plate structure 50 extending across the open bottom of the outer casing 48. The base plate 50 has a centrally threaded opening 52 extending therethrough for threadingly engaging a threaded boss 28 formed on the end of the inner cylinder 34. The outer periphery of the base plate 50 is connected to the outer casing 48 by a mechanical seaming operation. The outer edge of the outer casing 48 provides a gasket seal 54 that engages a raised lip or shoulder 56 on the outer tube 32 of the lower portion 18 of the housing 12. The gasket seal 54 seals against the lip 56 when the threaded opening 52 of the base plate 50 is threaded onto the threaded boss 28 of the inner cylinder 34 and threaded into a tight engagement of the upper portion 16 and the lower portion 18 of the housing 12.

To filter fuel, the filter media 23 is housed within the upper portion 16 of the housing 12, as seen in FIG. 1. The filter media 23 is preferably fabricated from a hydrophobic paper filter media formed into a tubular concentric structure wherein the bottom of the filter media 23 is attached and sealed to the base plate 50. The inner core of the filter media 23 is supported by a rib-like metallic structure 60 that allows fuel to pass through the filter media 23 while maintaining the structural integrity of the filter media 23. The fuel inlet tube 42 extends through the inner core to the top of the filter media 23. At the top of the filter media 23, a grommet 62 seals the fuel inlet tube 42 to the inner core of the filter media 23. The flow director 64 directs fuel to the bottom of the filter media 23 SO that the fuel progressively wets and dirties the filter media 23 from the bottom to the top of the filter media 23.

To direct fuel from the top of the filter media 23 to the bottom of the filter media 23 without saturating the filter media 23, a flow director 64 is connected to the top of the filter media 23 The flow director 64 is a plastic cup-shaped structure that is inverted over the filter media 23. The substantially flat top portion of the flow director 64 is connected and sealed to the top of the filter media 23 as well as to the grommet 62. As the flow director 64 extends over the sides of the filter media 23, the sidewalls 65 of the flow director 64 gradually extend radially outward from the filter media 23 as the flow director 64 extends downward. The sidewalls 65 of the flow director 64 end slightly above the bottom of the filter media 23 and the base plate 50.

The present invention is not limited to the sidewalls 65 of the flow director 64 gradually extending radially outward from the filter media 23, but rather, the sidewalls 65 of the flow director 64 may also extend straight downward, substantially parallel to the outer surface of the filter media 23. In addition, the end of the flow director 64 may end further up from the base plate 50 than disclosed in the preferred embodiment.

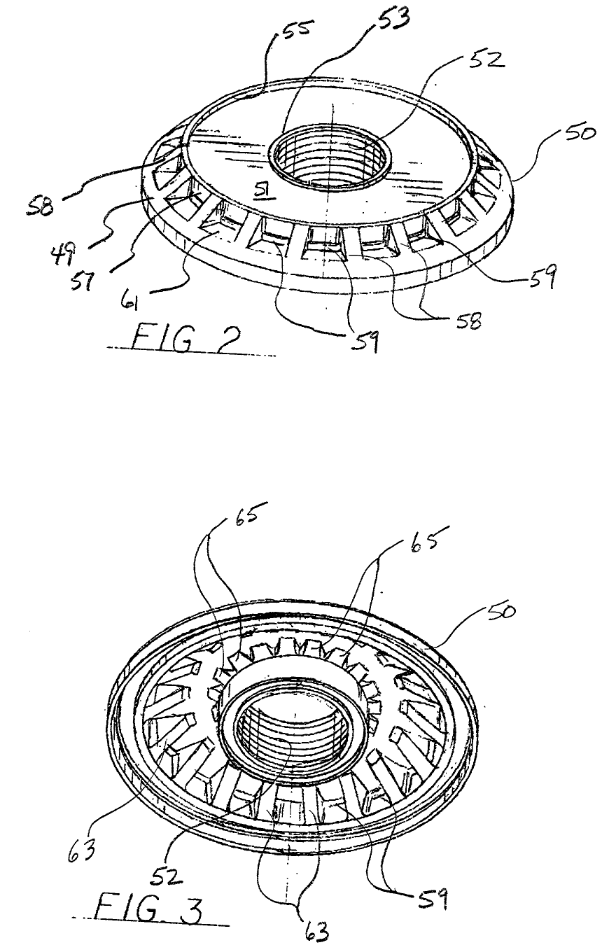

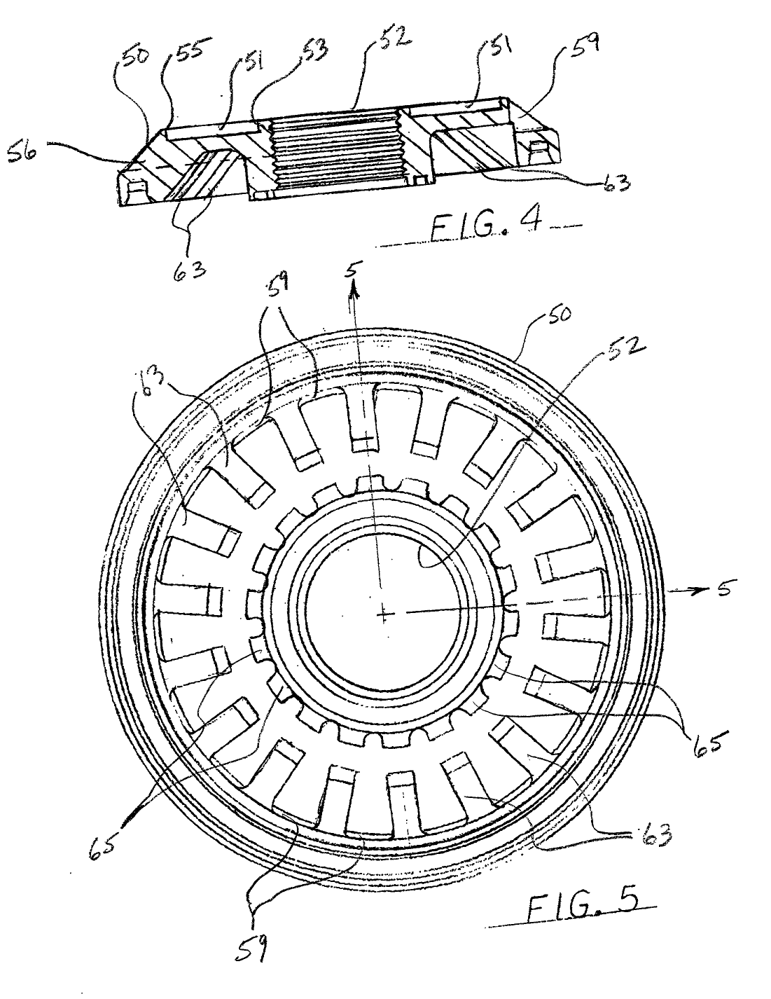

The base plate 50 is designed to direct fuel upward to the filter media 23 while allowing water and contaminants to pass through to the collection chamber 20 in the lower portion 18 of the housing 12. As seen in FIGS. 2-6, the base plate 50 generally has a frusto-conical shape wherein a recessed, substantially flat plateau or surface 51 is formed on the top of the base plate 50 for mounting the bottom of the filter media 23 thereon. Both the inner and outer periphery 53, 55, respectively, of the plateau 51 have a raised shoulder to help locate and seal the filter media 23 to the base plate 50. The outer periphery 55 of the plateau 51 has a wall 57 which extends downward to a substantially flat landing 61 that extends radially outward to the outer periphery of the base plate 50. A plurality of triangular shaped ribs 58 extend from the outer periphery of the base plate 50 to an outer periphery 49 of the plateau 51. Slotted openings 59 are provided through the base of wall 57 between each of the ribs 58. The underside of the base plate 50 has a recessed cup shape wherein triangular shaped ribs 63 extend from the outer periphery of the base plate 50 to the underside of the plateau 51. Smaller ribs 65 extend from the threaded boss 52 to the underside of the plate 51 to further support the threaded boss 52. The base plate 50 allows the lighter fuel to be directed upward to the filter media 23 while the slotted openings 59 allow the heavier water and contaminants to pass through to the collection chamber 20.

In order to melt any paraffin waxes that may clog the filter media 23 during cold weather, the present invention 10 provides a heater 66 mounted in the lower portion 18 of the housing 12 directly below the base plate 50. A portion of the heater 66 is preferably mounted adjacent the slotted openings 59 in the base plate 50 so that the heat from the heater 66 may radiate directly through and around the base plate 50.

To drain water and contaminants from the lower portion 18 of the housing 12, a drain plug 68 may be installed in the bottom 36 of the lower portion 18 of the housing 12. Other conventional accessories, such as a water sensor (not shown), may also be mounted within the lower portion 18 of the housing 12.

In operation, fuel enters the fuel inlet 22 and is directed through the fuel inlet tube 42 to the top of the filter media 23 within the upper portion 16 of the housing 12. The fuel cascades over the top of the filter media 23 which is covered by a top portion of the flow director 64. The fuel continues to be directed radially outward away from the filter media 23 by flow director 64. As the fuel falls to the bottom of the flow director 64 and to the top of the base plate 50, the ribs 58 on the base plate 50 direct the lighter weight fuel inward and upward toward the filter media 23 while the heavier water particles and contaminants hit the landing 61 and fall through the slotted openings 59 provided in the wall 57 of the base plate 50. The separation of water and contaminants from the fuel prior to wetting the filter media 23 provides a cleaner fuel to the filter media 23 while allowing the water and contaminants to fall to the collection chamber 20 in the lower portion 18 of the housing 12. This reduces the degree of exposure of water and contaminants to the filter media 23 so as to enhance and extend the life of the filter media 23.

Once the fuel passes through the filter media 23, the filtered fuel is directed from the inner core of the filter media 23 to the lower portion 18 of the housing 12 through fuel outlet 24. The fuel outlet tube 40 directs the filtered fuel from the lower portion 18 of the housing 12 to a fuel consuming device (not shown). At periodic intervals, water and contaminants may be drained from the collection chamber 20 of the lower portion 18 of the housing 12 by opening the drain plug 68 and allowing the heavier water and contaminants to be drained from the apparatus 10. When the filter media 23 becomes clogged with dirt and other contaminants, the upper portion 16 of the housing 12 may simply be unscrewed from the threaded boss of the inner cylinder 34 and replaced with a new spin-on filter that is inserted onto the inlet tube 42 and threaded onto the inner cylinder 34 of the lower portion 18 of the housing 12.

While the invention has been described in connection with what is presently considered to be the most practical and preferred embodiment, it is to be understood that the invention is not to be limited to the disclosed embodiments, but on the contrary, it is intended to cover various modifications and equivalent arrangements included within the spirit and scope of the appended claims, the scope is to be accorded the broadest interpretation so as to encompass all such modifications and equivalent structures as is permitted under the law.

1. A fuel processing and filtering apparatus for separating water and impurities from fuel, comprising:
a housing having an upper portion for filtering fuel and a lower portion defining a collection chamber;
a filter media housed within said upper portion of said housing for filtering said fuel wherein said fuel flows from an unfiltered side of said filter media toward a filtered side of said filter media;
a fuel inlet directing said fuel to said unfiltered side of said filter media;
a fuel outlet in communication with said filtered side of said filter media,
a flow director connected to said filter media and extending along said unfiltered side of said filter media wherein said fuel flows from said fuel inlet along an outer surface of said flow director to settle out water and contaminants from said fuel; and
a plate separating said upper portion and said lower portion of said housing and directing fuel toward said unfiltered side of said filter media, and said plate having at least one narrow opening extending therethrough for allowing said water and impurities to pass through said opening to said lower portion of said housing.

2. The fuel processing and filter apparatus stated in claim 1, wherein said narrow opening further comprises:
at least one radial slot extending through said plate.

3. A fuel processing and filtering apparatus as stated in claim 1, further comprising:
at least one rib extending across said plate wherein said opening extends to and from said rib.

4. A fuel processing and filtering apparatus as stated in claim 1, further comprising:
said fuel inlet entering said lower portion of said housing and directing said fuel to a top of said filter media.

5. The fuel processing and filtering apparatus stated in claim 1, further comprising:
said fuel outlet exiting said lower portion of said housing.

6. A fuel processing and filtering apparatus stated in claim 1, further comprising:
said filter media having a substantially tubular configuration wherein said outer surface of said filter media corresponds to said unfiltered side of said filter media and said inner core of said filter media corresponds to said filtered side of said filter media.

7. The fuel processing and filtering apparatus stated in claim 1, further comprising:
a heater disposed within said lower chamber of said housing directly under said plate.

8. A fuel processing and filtering apparatus for separating water and impurities from fuel, comprising:
a housing having an upper portion for filtering fuel and a lower portion defining a collection chamber;
a filter media housed within said upper portion of said housing for filtering said fuel wherein said fuel flows from an unfiltered side of said filter media toward a filtered side of said filter media;
a fuel inlet entering said lower portion of said housing and directing said fuel to an unfiltered side of said filter media;
a fuel outlet in communication with said filtered side of said filter media and extending to said lower portion of said housing;
a flow director connected to said filter media and extending along said unfiltered side of said filter media wherein said fuel flows from said fuel inlet along the outer surface of said flow director to settle out water and contaminants from said fuel; and
a plate separating said upper portion and said lower portion of said housing and directing fuel toward said unfiltered side of said filter media, and said plate having at least one radial slot extending therethrough for allowing said water and said impurities to pass through said slot to said lower portion of said housing.

9. The fuel processing and filter apparatus stated in claim 8, further comprising:
said filter media having a substantially tubular configuration wherein said outer surface of said filter media corresponds to said unfiltered side of said filter media, and said inner core of said filter media corresponds to said filtered side of said filter media.

10. The fuel processing and filtering apparatus as stated in claim 9, further comprising:
said fuel inlet extending upward through said inner core of said filter media to direct fuel to a top of said unfiltered side of said filter media.

11. The fuel processing and filter apparatus stated in claim 10, further comprising:
said fuel inlet and said fuel outlet extending through said upper and lower portions of said housing in a substantially concentric fashion.

12. The fuel processing and filter apparatus as stated in claim 9, further comprising:
a seal mounted between said fuel inlet and the top of said filter media to prevent unfiltered fuel from passing through to said fuel outlet.

13. The fuel processing and filtering apparatus stated in claim 8, further comprising:
said filter media being connected to said plate, and said plate being located directly under said flow director.

14. The fuel processing and filtering apparatus stated in claim 8, further comprising:
a heater disposed within said lower chamber of said housing and mounted directly under said plate wherein at least a portion of said heater is directly adjacent said radial slot.

15. The fuel processing and filtering apparatus stated in claim 8, further comprising:
said plate having a plurality of ribs extending radially across said plate, and said slots extending between said ribs.

16. A fuel processing and filtering apparatus for separating water and impurities from fuel, comprising:
a housing having an upper portion for filtering fuel and a lower portion defining a collection chamber;
a substantially tubular filter media housed within said upper portion of said housing for filtering said fuel wherein said fuel flows from an outer surface of said filter media toward an inner core of said filter media;
a fuel inlet entering said lower portion of said housing and directing said fuel through said inner core of said filter media to an unfiltered side of said filter media;
a fuel outlet in communication with said filtered side of said filter media and extending to and exiting from said lower portion of said housing;
a flow director connected to said filter media and extending along said unfiltered side of said filter media wherein said fuel flows from said inlet along the outer surface of said flow director to settle out water and contaminants from said fuel; and
a base plate separating said upper portion from said lower portion of said housing and directing fuel toward said unfiltered side of said filter media, and said plate having a plurality of ribs extending radially and upwardly across said plate for directing fuel toward said unfiltered side of said filter media and a plurality of radial slots extending between said ribs and through said plate for allowing said water and impurities to pass through said slots to said lower portion of said housing.

17. The fuel processing and filtering apparatus stated in claim 16, further comprising:
said fuel inlet and said fuel outlet extending through said upper and lower portions of said housing in a substantially concentric fashion.

18. The fuel processing and filtering apparatus stated in claim 16, further comprising:
a seal mounted between said fuel inlet and the top of said filter media to prevent unfiltered fuel from passing through to said fuel outlet.

19. The fuel processing and filtering apparatus stated in claim 16, further comprising:
said filter media sealedly connected to said plate, and said plate located directly under said flow director.

19. The fuel processing and filtering apparatus stated in claim 15, further comprising:
a heater disposed within said lower chamber of said housing and directly below said plate wherein at least a portion of said heater is directly adjacent said radial slots.
